(19) United States
(12) Patent Application Publication
(10) Pub. No.: US 2016/0266900 A1
(43) Pub. Date: Sep. 15, 2016

(54) INFORMATION PROCESSING APPARATUS, WORK FLOW CREATION METHOD, AND STORAGE MEDIUM

(71) Applicant: FUJITSU LIMITED, Kawasaki-shi (JP)

(72) Inventor: Yasuhisa ANZAI, Yokohama (JP)

(73) Assignee: Fujitsu Limited, Kawasaki-shi (JP)

(21) Appl. No.: 15/040,293

(22) Filed: Feb. 10, 2016

(30) Foreign Application Priority Data
Mar. 9, 2015 (JP) 2015-046128

(51) Int. Cl. G06F 9/30

(52) U.S. Cl. CPC G06F 9/3005

(57) ABSTRACT

An information processing apparatus including a memory; and a processor coupled to the memory configured to receive a usage application in which at least one group among a plurality of groups including at least one resource related to a computer system is designated as a usage object, specify at least one administrator corresponding to the at least one group by referring to group information including at least the plurality of groups and information about an administrator corresponding to each of the plurality of groups, extract at least one authorizer from the at least one administrator based on a relationship between the at least one group and a relationship between the at least one administrator, and generate a work flow including the at least one authorizer.

### CROSS-REFERENCE TO RELATED APPLICATION

This application is based upon and claims the benefit of priority of the prior Japanese Patent Application No. 2015-046128, filed on Mar. 9, 2015, the entire contents of which are incorporated herein by reference.

### FIELD

The embodiments discussed herein relate to an information processing apparatus, a work flow creation method, and a storage medium.

### BACKGROUND

Generally, a person who wishes to purchase an article or service in a company presents an application form pertaining to the purchase of the article or the service. The application form is subject to authorization by an authorizer and further subject to an examination by an examiner in a higher position. The use of resources (such as computing resources on a virtual machine and the like or a network) offered by a cloud service similarly involves carrying out procedures represented by a flow involving the presentation of an application form, an authorization, and an examination (referred to below as “authorization flow”).

An authorization flow may be automated using a work flow system and the like. The authorizer and the examiner are selected based on a general organization structure in a work flow system. For example, when an employee wishes to use a cloud service in a given office, the manager of the office is assigned as the authorizer and a department manager of the department to which the office belongs is assigned as the examiner. Examples of related art include Japanese Laid-open Patent Publication No. 2013-200753, Japanese Laid-open Patent Publication No. 2007-156520, Japanese Laid-open Patent Publication No. 2008-130006, and Japanese Laid-open Patent Publication No. 2005-222243.

Meanwhile, when an application for using resources offered by a cloud service is carried out, the determination of the suitability of the usage application is very likely to be difficult if the persons are not familiar with the cloud service. For example, when an application indicating “a desire to use three virtual machines offered by cloud service A” is issued, it would be difficult for a person not familiar with the cloud service A to determine whether the application is suitable based on the contents of the applicant's duties.

When defining an authorization flow in consideration of this state of affairs, the conventional work flow system desirably amends and redefines the authorization flow each time a new service usage application is issued. In this case, while an existing authorization flow is effective during a period until the new authorization flow is defined, there is a possibility that the application may be authorized even though the determination of suitability by the authorizer has not yet been carried out. Alternatively, when an existing authorization flow is canceled during the period until a new authorization flow is defined, it may take time until the usage of a useful service is authorized.

Moreover, if there is an individual who is well acquainted with the cloud service and that individual is assigned to be an authorizer or an examiner, the authorizations and examinations may be concentrated on that individual and the work load for that individual may exceed a realistic scope. As a result, it is desirable to improve the flexibility of a work flow pertaining to applications for using computer system resources.

### SUMMARY

According to an aspect of the invention, an information processing apparatus including a memory; and a processor coupled to the memory configured to receive a usage application in which at least one group among a plurality of groups including at least one resource related to a computer system is designated as a usage object, specify at least one administrator corresponding to the at least one group by referring to group information including at least the plurality of groups and information about an administrator corresponding to each of the plurality of groups, extract at least one authorizer from the at least one administrator based on a relationship between the at least one group and a relationship between the at least one administrator, and generate a work flow including the at least one authorizer.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 illustrates an example of a work flow system according to an embodiment of the present disclosure;

FIG. 2 illustrates an example of a hardware configuration of a work flow creation device according to an embodiment of the present disclosure;

FIG. 3 illustrates an example of a functional configuration of the work flow creation device according to an embodiment of the present disclosure;

FIG. 4 illustrates an example of cloud services that are objects of a usage application;

FIG. 5 is a view for explaining a resource pool according to the present embodiment;

FIG. 6 is a flow chart for explaining an example of an operating procedure executed by a work flow creation device;

FIG. 7 illustrates an example of a configuration of a pool information storage unit;

FIG. 8 illustrates an example of a configuration of a template information storage unit;

FIG. 9 illustrates an example of a configuration of a VM information storage unit;

FIG. 10 illustrates an example of a NET information storage unit;

FIG. 11 illustrates an example of an examination condition storage unit;

FIG. 12 is a view for explaining an authorizer exclusion process based on a containment relationship among resource pools;

FIG. 13 illustrates an example of an organization information storage unit;

FIG. 14 illustrates an example of a user information storage unit;

FIG. 15 is a view for explaining a first detailed example of an authorizer and examiner specification;

FIG. 16 illustrates a first example of an authorization flow;

FIG. 17 is a view for explaining a second detailed example of an authorizer and examiner specification; and

FIG. 18 illustrates a second example of an authorization flow.

### DESCRIPTION OF EMBODIMENT

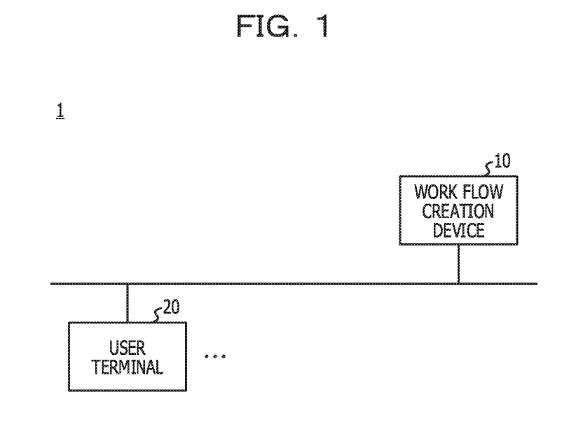

An embodiment of the present disclosure will be explained with reference to the drawings. FIG. 1 illustrates an example of a work flow system according to an embodiment of the present disclosure. A work flow system 1 depicted in FIG. 1 is a computer system operated in a certain corporation (referred to below as “corporation C”). The work flow system 1 includes a plurality of user terminals 20 and a work flow creation device 10. The user terminals 20 and the work flow creation device 10 are connected in a manner that allows communication over a network such as a local area network (LAN), an intranet, or the Internet.

The user terminals 20 are terminals used by employees (referred to below as “users”) of the corporation C. For example, the user terminals 20 are used by users who apply to use a cloud service, users who authorize the usage application, and users who examine the usage application. For example, a personal computer (PC), a smartphone, or a tablet terminal and the like may be used as the user terminal 20. For convenience, the term “examine” refers to an authorization carried out by a user in a higher position than that of the authorizer in the present embodiment. Therefore, an “examination” may be understood as a “second authorization” for example.

The work flow creation device 10 is at least one computer that creates a work flow (referred to below as “authorization flow”) for automating procedures such as a usage application for a cloud service, an authorization of the usage application, and an examination of the usage application, and that controls the execution of the authorization flow. The computer that creates the authorization flow and the computer that controls the execution of the authorization flow may be different computers.

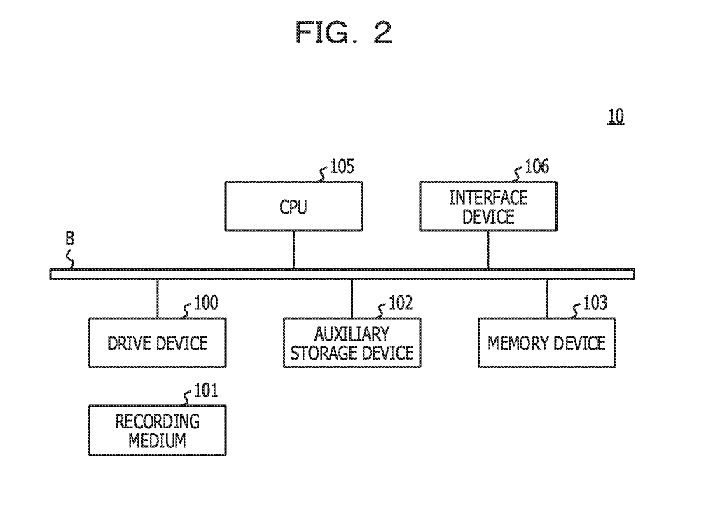

FIG. 2 illustrates an example of a hardware configuration of the work flow creation device according to an embodiment of the present disclosure. The work flow creation device 10 in FIG. 2 includes a drive device 100, an auxiliary storage device 102, a memory device 103, a CPU 104, and an interface device 105 all connected to each other over a bus B.

A program for realizing the operations of the work flow creation device 10 is provided by a recording medium 101. When the recording medium 101 with a recorded program is set in the drive device 100, the program is installed from the recording medium 101 to the auxiliary storage device 102 via the drive device 100. However, the installation of the program may not typically be carried out by the recording medium 101. The program may also be downloaded from another computer via a network. The auxiliary storage device 102 stores the installed program as well as desired files and data and the like.

The memory device 103 reads out and stores the program from the auxiliary storage device 102 when there is an instruction to activate the program. The CPU 104 executes functions pertaining to the work flow creation device 10 according to the program stored in the memory device 103. The interface device 105 is used as an interface for connecting to a network.

Portable memory media such as a CD-ROM, a DVD disk, or a USB memory and the like may be cited as examples of the recording medium 101. The auxiliary storage device 102 is, for example, a hard disc drive (HDD) or a flash memory. Both the recording medium 101 and the auxiliary storage device 102 correspond to computer-readable recording media.

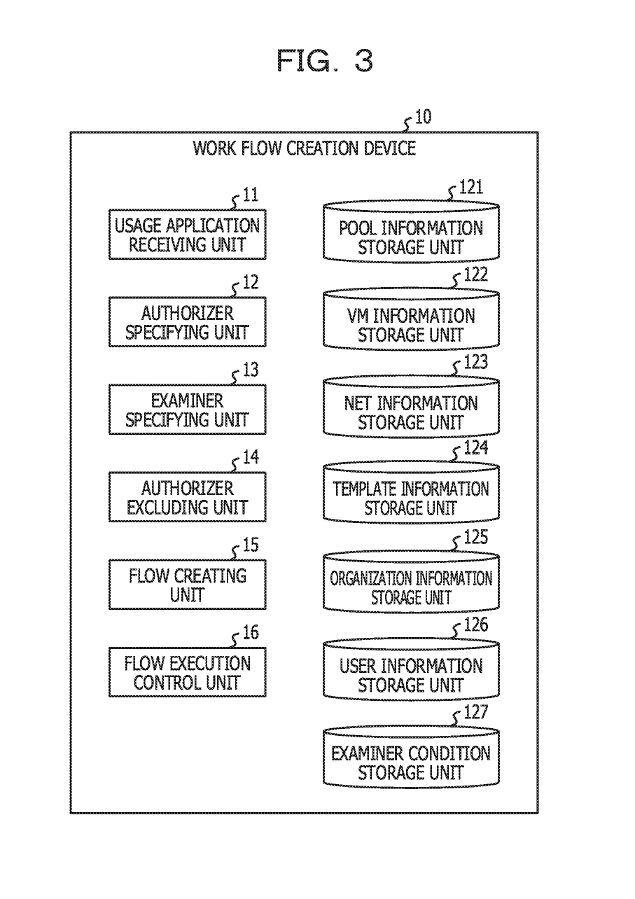

FIG. 3 illustrates an example of a functional configuration of the work flow creation device according to an embodiment of the present disclosure. The work flow creation device 10 in FIG. 3 includes a usage application receiving unit 11, an authorizer specifying unit 12, an examiner specifying unit 13, an authorizer excluding unit 14, a flow creating unit 15, and a flow execution control unit 16. The units are realized by the CPU 104 executing one or more programs installed in the work flow creation device 10. The work flow creation device 10 uses a pool information storage unit 121, a VM information storage unit 122, a NET information storage unit 123, a template information storage unit 124, an organization information storage unit 125, a user information storage unit 126, and an examination condition storage unit 127. The storage units can be realized, for example, by using the auxiliary storage device 102 or by using storage devices connectable over a network to the work flow creation device 10.

The usage application receiving unit 11 receives, from any of the user terminals 20, a usage application for a resource offered by a cloud service. Examples of resources offered by a cloud service include computing resources and a network. In the present embodiment, a virtual machine (VM) is exemplified as a computing resource. However, a physical computer may be used as a computing resource pertaining to the usage application. For example, when cloud service resources are desired for carrying out development work by a section involved in development work in the corporation C, a usage application for the resources is issued by a user in the section.

Possible cloud services in a usage application in the corporation C may include a public cloud offered by a company outside of the corporation C as well as a private cloud inside the corporation C.

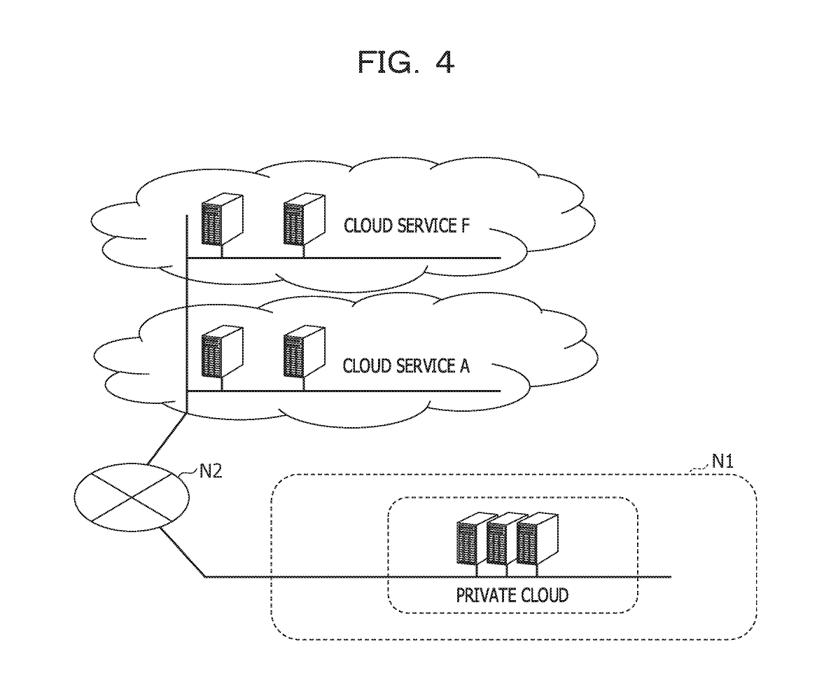

FIG. 4 illustrates an example of cloud services that are objects of a usage application. FIG. 4 exemplifies a private cloud constructed within an intranet N1 inside the corporation C, and a public cloud A and a public cloud F which are public clouds that can be accessed from the intranet N1 over an internet N2.

Returning to FIG. 3, the authorizer specifying unit 12 specifies an authorizer corresponding to the usage application received by the usage application receiving unit 11. That is, the authorizer is determined automatically based on the application contents of the usage application in the present embodiment.

The usage object is designated in units of resource pools in the usage application in the present embodiment. A resource pool according to the present embodiment is a concept corresponding to collection of one or more resources, that is, a group of resources.

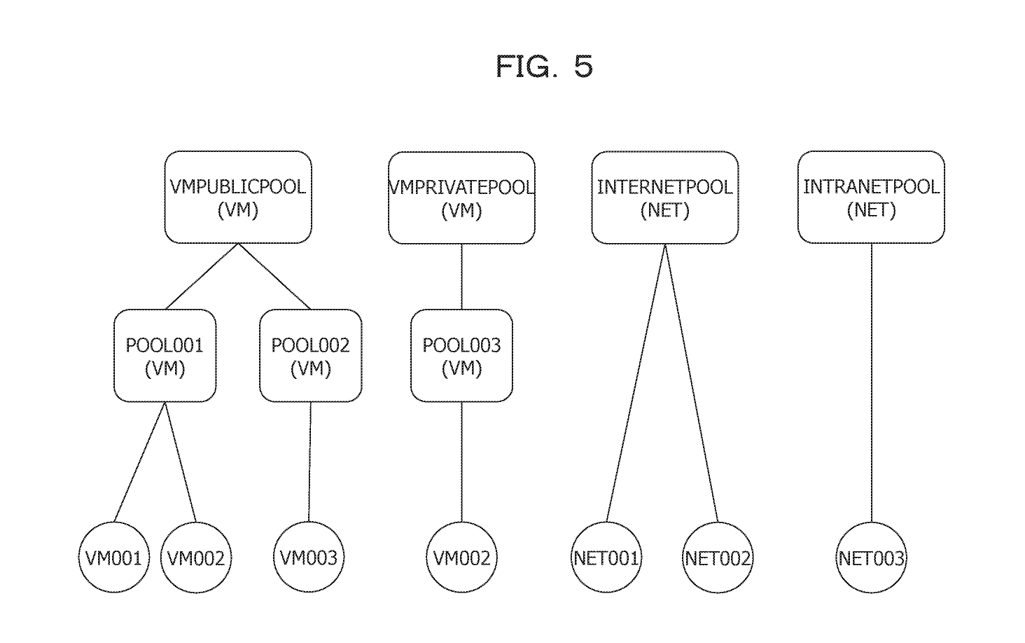

FIG. 5 is a view for explaining a resource pool according to the present embodiment. The rounded corner rectangles indicate resource pools and the circles indicate resources. The characters inside the rounded corner rectangles refer to IDs of resource pools (referred to below as “pool IDs”). The characters inside the brackets indicate the type of resource belonging to the resource pool. “VM” refers to a virtual machine and “NET” refers to a network. The characters inside the circles refer to IDs of resources (referred to below as “resource IDs”). Hereinbelow, a resource having the resource type “VM” (i.e., a virtual machine) is referred to as a “VM resource”, and resource having the resource type “NET” (i.e., a network) is referred to as a “NET resource”.

The resource pool of VM resources having the pool ID of “VMPUBLICPOOL” is illustrated in FIG. 5 as including, for example, the resource pool having the pool ID of “POOL001” and the resource pool having the pool ID of “POOL002”. That is, a resource pool may have a containment relationship with another resource pool.

The resource pool having the pool ID “POOL001” is illustrated as including the VM resource having the resource ID “VM001” and the VM resource having the resource ID “VM002”. The resource pool having the pool ID “POOL002” is illustrated as including the VM resource having the resource ID “VM003”.

Similarly, the resource pool having the pool ID “VMPRIVATEPOOL” is illustrated as including the resource pool having the pool ID “POOL003”, and the resource pool having the pool ID “POOL003” is illustrated as including the VM resource having the resource ID “VM002”. The resource pool having the pool ID “INTERNETPOOL” is illustrated as including the NET resource having the resource ID “NET001” and the NET resource having the resource ID “NET002”. Furthermore, the resource pool having the pool ID “INTRANETPOOL” is illustrated as including the NET resource having the resource ID “NET003”.

The resource pools (groups of resources) illustrated in FIG. 5 are defined for example by a system administrator in the corporation C. That is, the resource pools may be defined in any way by the system administrator. For example, a resource pool may be defined as one that is a collection of VM resources for which the usage fee is low but the performance is poor, or one that is a collection of VM resources for which the usage fee is high and the performance is good. A resource pool may be defined as one for which 24-hour operation is guaranteed. A resource pool may also be defined as one that is a combination of resources belonging to the private cloud and resources belonging to a public cloud.

The usage object is designated in the usage application with contents such as “one VM resource in POOL001”.

The authorizer specifying unit 12 refers to the pool information storage unit 121 and specifies an authorizer corresponding to the resource pool designated in the usage application. The pool information storage unit 121 stores users to become authorizers of resource pool usage applications for each resource pool depicted in FIG. 5.

The examiner specifying unit 13 refers to the examination condition storage unit 127 and specifies an examiner corresponding to the usage fee of each resource that is expected to be assigned as the usage object among the resources belonging to the resource pool designated in the usage application. The examination condition storage unit 127 stores information indicating examiners in accordance with usage fees. The usage fee of a resource can be calculated by referring to the VM information storage unit 122 or the NET information storage unit 123. The VM information storage unit 122 stores usage fees and the like for each VM resource. The NET information storage unit 123 stores usage fees and the like for each NET resource.

The authorizer excluding unit 14 excludes a portion of the authorizers from the authorization flow when a plurality of authorizers are specified by the authorizer specifying unit 12. In the present embodiment, an authorizer in the authorization flow is specified based on the resource pool designated in the usage application. Therefore, when a plurality of resource pools are designated as usage objects in one usage application, there is a possibility that a plurality of authorizers may be designated in one usage application. An increase in the number of authorizers may hinder the smooth progress of an authorization flow. The authorizer excluding unit 14 therefore excludes a portion of the authorizers from the authorization flow to allow for the smooth progress of the authorization flow. The exclusion of a portion of authorizers is carried out based on the information stored in the organization information storage unit 125 and the information stored in the user information storage unit 126. The organization information storage unit 125 stores information indicating the hierarchical structure of the organization of the corporation C and the user information storage unit 126 stores the titles and affiliated organizations of each user in the corporation C. Therefore, the hierarchical relationships of the plurality of authorizers can be understood from the above information. The authorizer excluding unit 14 chooses an authorizer having a position that is relatively low in the hierarchical relationship as an authorizer to be excluded. For example, if a department head and a section head are indicated as authorizers, the section head is excluded from the authorizers.

The authorizer excluding unit 14 further excludes an authorizer based on the containment relationship among the resource pools indicated in FIG. 5. That is, the authorizer excluding unit 14 excludes an authorizer corresponding to a resource pool contained in another resource pool among a plurality of resource pools designated as the usage objects in the usage application.

The flow creating unit 15 creates work flow information of the authorization flow corresponding to the usage application based on the processing results by the authorizer specifying unit 12, the examiner specifying unit 13, and the authorizer excluding unit 14. Work flow information is information for defining the work flow.

The template information storage unit 124 stores templates for usage applications. A template for a usage application includes stylized application contents. That is, a user who issues a usage application is able to easily designate a usage object by selecting a template.

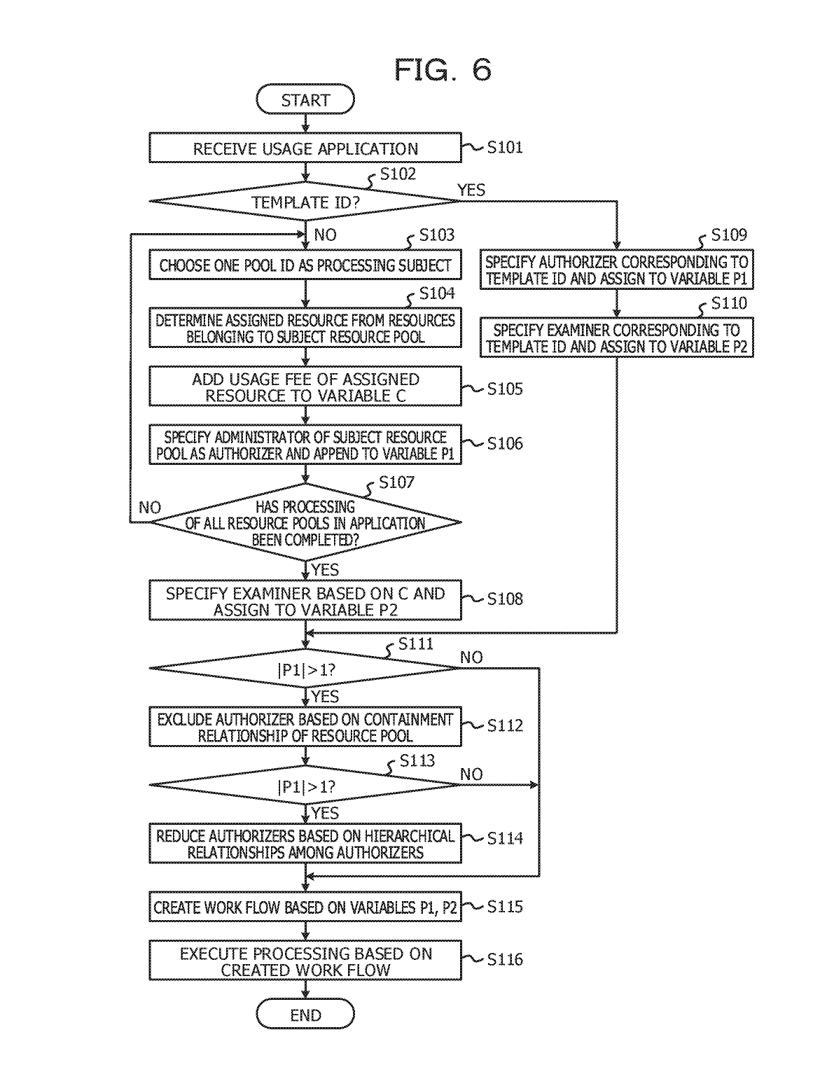

Next, operating procedures executed by the work flow creation device 10 will be explained. FIG. 6 is a flow chart for explaining an example of an operating procedure executed by a work flow creation device.

In S101, the usage application receiving unit 11 receives a usage application transmitted from any of the user terminals 20. The resource pool chosen as the usage object in the usage application may be selected, for example, from the information stored in the pool information storage unit 121 or the information stored in the template information storage unit 124.

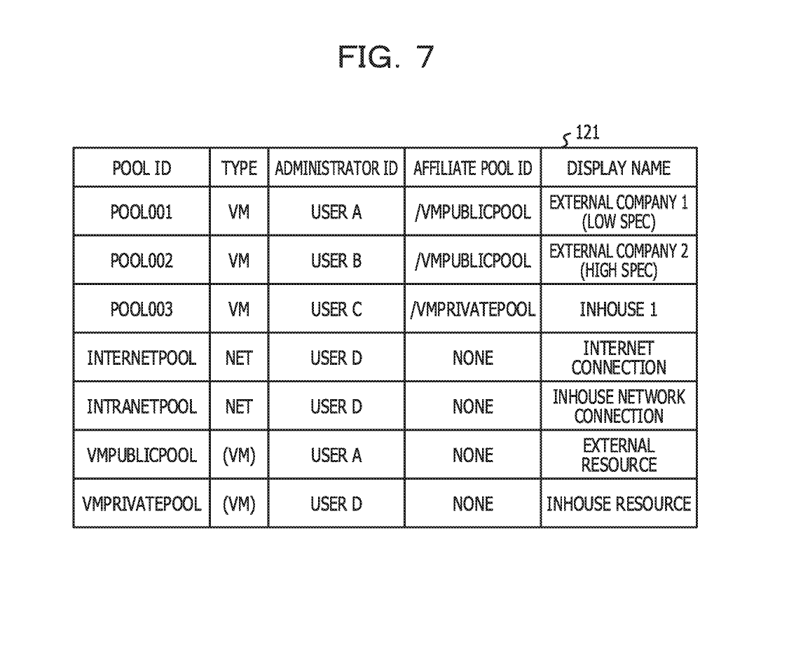

FIG. 7 illustrates an example of a pool information storage unit. The pool information storage unit 121 in FIG. 7 stores a pool ID, a type, an administrator ID, an affiliate pool ID, and a display name for each resource pool defined in the corporation C.

The pool ID is identification information for each resource pool. The type is the type of resource (“VM” or “NET”) in the resource pool. The administrator ID is a user ID of the administrator of the resource pool. For example, a person familiar with the resource pool in question is desirably assigned as the administrator. The user ID is identification information for each user. The affiliate pool ID is the pool ID of the resource pool that contains the resource pool in question. That is, the affiliate pool ID is information that indicates the containment relationship among the resource pools in FIG. 5. The display name is a display name for the resource pool.

For example, a list of display names of resource pools are displayed on the user terminal 20 of the user who will issue the usage application. Therefore, characters that indicate the characteristics of the resource pool may be used as the display name. Useful information for selecting a usage object can be offered to the user issuing the usage application by using characters that indicate the characteristics of the resource pool.

The user selects at least one display name (resource pool) from the list of displayed display names and enters the amount of resources the user wishes to use for each resource pool. However in the present embodiment, the amount of resources for the NET resources may not be inputted. Therefore, a usage application including the following application contents is transmitted from the user terminal 20 to the work flow creation device 10.

“Use of two VM resources from POOL001 and INTERNETPOOL”

The above application contents signifies that the user wishes to use two VM resources among the VM resources belonging to the resource pool having the pool ID “POOL001” and any of the NET resources belonging to the resource pool having the pool ID “INTERNETPOOL”.

Conversely, when the usage object is designated by the selection of a template, the information stored in the template information storage unit 124 is displayed on the user terminal 20.

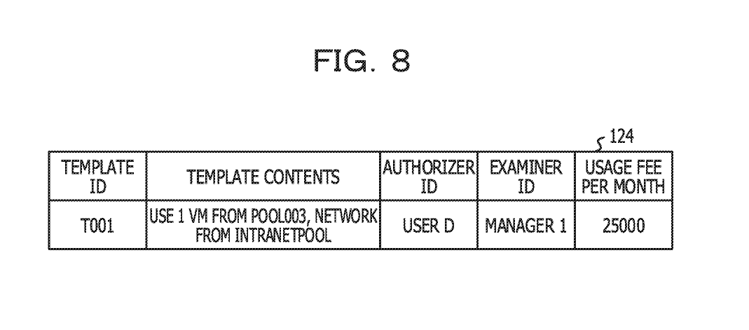

FIG. 8 illustrates an example of a configuration of a template information storage unit. The template information storage unit 124 in FIG. 8 stores a template ID, template contents, an authorizer ID, an examiner ID, and the usage fee per month and the like for each template.

The template ID is identification information for each template. While only one template is illustrated in FIG. 8, a plurality of templates may be defined. The template contents represent information indicating the resource pool designated as the usage object in the template. The authorizer ID is the user ID of a user who becomes the authorizer related to the template. The examiner ID is the user ID of a user who becomes the examiner related to the template. The usage fee per month is a usage fee per one month indicated in the template.

For example, the template contents and usage fee per month are displayed for each template on the user terminal 20 of the user who issues the usage application. When any template is selected, the usage application which includes the template ID of the template as the application contents is transmitted from the user terminal 20 to the work flow creation device 10.

Next, the authorizer specifying unit 12 determines whether the application contents of the received usage application is a template ID (S102). If the application contents of the usage application do not indicate a template ID (S102, No), the authorizer specifying unit 12 chooses one pool ID among the one or more pool IDs included in the application contents as the processing subject (S103). A resource pool pertaining to the pool ID that is the processing subject is referred to as a “subject pool”.

Next, the authorizer specifying unit 12 determines the resource assigned in the usage application (referred to below as “assigned resource”) among the resources belonging to the subject pool (S104). For example, when the subject pool is a resource pool pertaining to a VM resource, the assigned resource is determined by referring to the VM information storage unit 122.

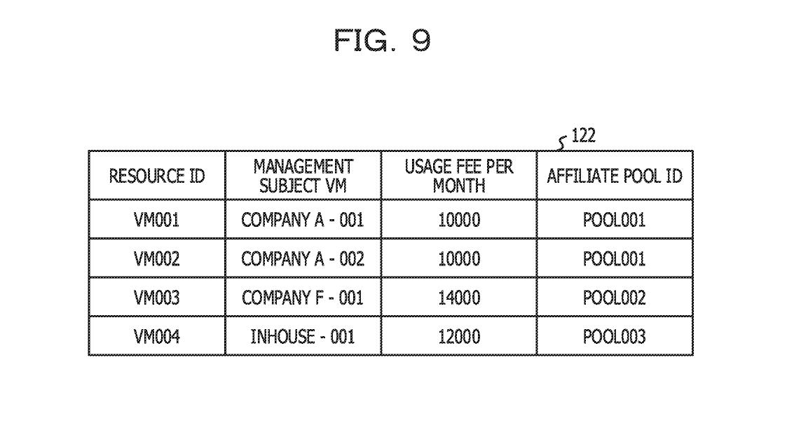

FIG. 9 illustrates an example of a configuration of a VM information storage unit. The VM information storage unit 122 in FIG. 9 stores a resource ID, a management subject VM, a usage fee per month, and an affiliate pool ID and the like for each VM resource belonging to any of the resource pools having a pool ID that is stored in the pool information storage unit 121.

The resource ID is identification information for each resource assigned by the work flow creation device 10. The management subject VM is identification information of the VM resource that is the offering source of the VM resource. The usage fee per month is a usage fee per one month of the VM resource. The affiliate pool ID is the pool ID of the resource pool (that contains the VM resource) to which the VM resource belongs. That is, the affiliate pool ID is information that indicates the containment relationships among the resources and the resource pools in FIG. 5.

If the subject pool is the resource pool pertaining to the VM resource, the quantity (number) of VM resources is also designated in the usage application. Therefore, the authorizer specifying unit 12 sets the VM resources of the quantity designated in the usage application among the VM resources in which the pool ID of the subject pool is the affiliate ID, as the assigned resources.

Conversely, when the subject pool is a resource pool pertaining to a NET resource, the assigned resource is determined by referring to the NET information storage unit 123.

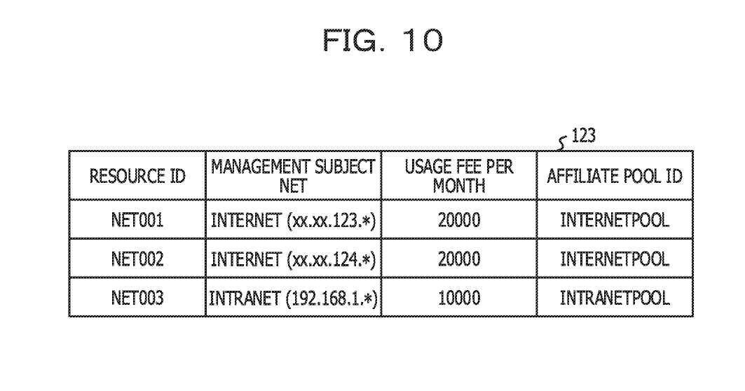

FIG. 10 illustrates an example of a NET information storage unit. The NET information storage unit 123 in FIG. 10 stores a resource ID, a management subject NET, a usage fee per month, and an affiliate pool ID for each NET resource indicated in FIG. 5.

The resource ID is identification information for each resource assigned by the work flow creation device 10. The management subject NET is identification information of the NET resource that is the offering source of the NET resource. The usage fee per month and the affiliate pool ID are the same as for the VM resource.

If the subject pool is a resource pool pertaining to a NET resource, the authorizer specifying unit 12 sets the NET resource in which the pool ID of the subject pool is the affiliate ID as the assigned resource.

Next, the authorizer specifying unit 12 adds the usage fee of the assigned resource determined in S104 to a variable C for storing the total amount of the usage fee (S105). The initial value of the variable C is zero. The usage fee added to the variable C is the usage fee per month stored in the VM information storage unit 122 or the NET information storage unit 123. If there is more than one assigned resources determined in step S104, the total of the usage fees of the plurality of assigned resources is added to C.

Next, the authorizer specifying unit 12 specifies the administrator ID stored in the pool information storage unit 121 related to the subject pool as the user ID of the authorizer in the authorization flow to be created. The authorizer specifying unit 12 appends the specified user ID to a variable P1 (S106). The variable P1 is a variable having a structure that is able to store a collection of authorizer user IDs and the initial value is blank.

S103 to S106 are executed with regard to all of the resource pools designated as the usage objects in the usage application (S107). As a result, the total amount of the usage fees of the resources pertaining to all of the resource pools is stored in the variable C. The authorizer user IDs specified for each resource pool are stored in the variable P1.

When S103 to S106 are executed for all of the resource pools designated as usage objects in the usage application (S107, Yes), the examiner specifying unit 13 applies the variable C to the information stored in the examination condition storage unit 127, specifies the user ID of the examiner of the authorization flow, and assigns the specified user ID to a variable P2 (S108). The variable P2 is a variable for storing the user ID of the examiner.

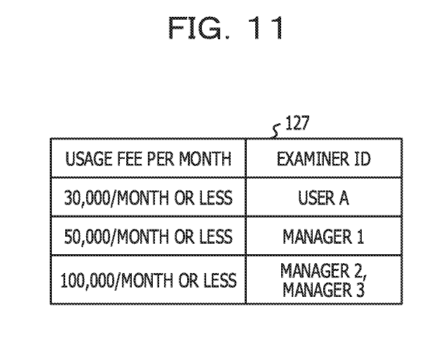

FIG. 11 illustrates an example of an examination condition storage unit. The examination condition storage unit 127 in FIG. 11 stores examiner IDs in association with ranges of usage fees. The examiner ID indicates the user ID of the user to become an examiner.

The examiner specifying unit 13 in S107 assigns the examiner ID corresponding to the range including the value of the variable C to the variable P2.

Meanwhile, if the application contents of the usage application are a template ID (S102, Yes), the authorizer specifying unit 12 assigns the authorizer ID stored in the template information storage unit 124 (FIG. 8) related to the template, to the variable P1 (S109). Next, the examiner specifying unit 13 assigns the authorizer ID stored in the template information storage unit 124 related to the template ID, to the variable P2 (S110).

Next, the authorizer excluding unit 14 determines whether |P1| is greater than one (S111). Here, |P1| indicates the number of user IDs stored in the variable P1. That is, it is determined whether or not a plurality of authorizers are specified.

If |P1| is equal to or less than one (S111, No), the routine advances to S115. If |P1| is greater than one (S111, Yes), the authorizer excluding unit 14 excludes a portion of the user IDs among the user IDs stored in the variable P1 from the variable P1 based on the containment relationships among the resource pools set as usage objects (S112).

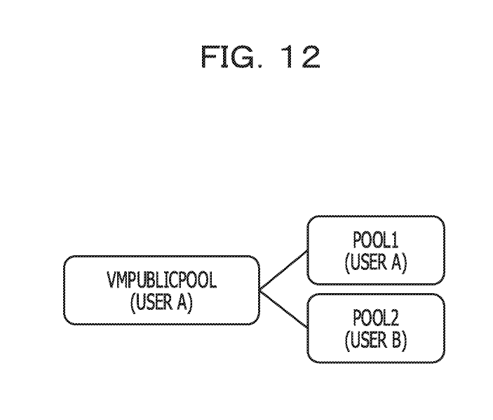

FIG. 12 is a view for explaining an authorizer exclusion process based on a containment relationship among resource pools. The “POOL001” and the “POOL002” are designated as usage objects in the usage application in FIG. 12. The two resource pools are both contained in “VMPUBLICPOOL” as indicated in FIG. 12. The user ID of the administrator of each resource pool is indicated in brackets in FIG. 12.

The administrator of the “VMPUBLICPOOL” is the “User A”, and the administrator of the “POOL002” is the “User B”. The “VMPUBLICPOOL” is a resource pool containing the “POOL002”. As a result, it is assumed that the administrator of the “VMPUBLICPOOL” is familiar with the “POOL002”. Thus in this case, the authorizer excluding unit 14 excludes the user ID of the administrator of the “POOL002” from the variable P1.

Next, the authorizer excluding unit 14 determines whether |P1| after the execution of S112 is greater than 1 (S113). If |P1| is equal to or less than one (S113, No), the routine advances to S115. If |P1| is greater than one (S113, Yes), the authorizer excluding unit 14 excludes a portion of the user IDs among the user IDs stored in the variable P1 from the variable P1 based on the hierarchical relationships among the plurality of authorizers (S114).

The authorizer excluding unit 14 refers to the organization information storage unit 125 and the user information storage unit 126 to understand the hierarchical relationships among the plurality of authorizers.

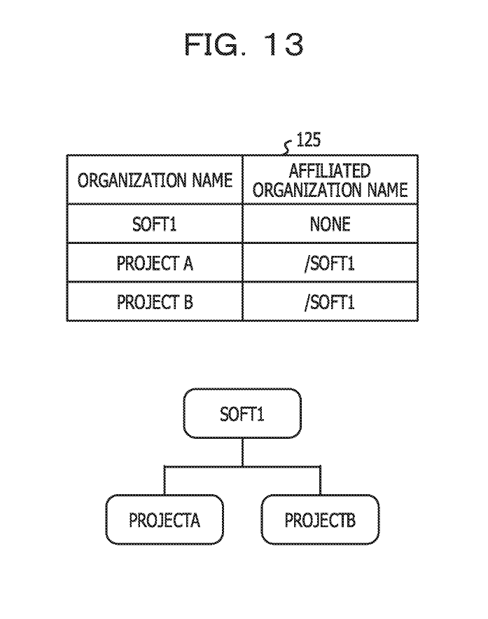

FIG. 13 illustrates an example of an organization information storage unit. The organization information storage unit 125 in FIG. 13 stores an organization name and an affiliated organization name for each organization in the corporation C. The organization name is the name of the organization. The affiliated organization name is the name of higher organization to which the organization belongs. The organization information storage unit 125 illustrated in FIG. 13 stores the information indicating the hierarchical structure (tree structure) illustrated at the bottom of FIG. 13.

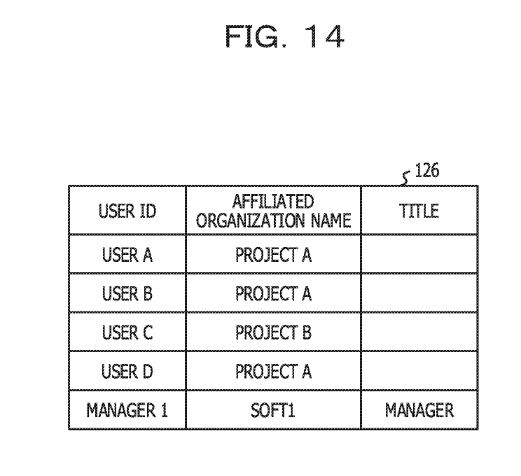

FIG. 14 illustrates an example of a user information storage unit. The user information storage unit 126 in FIG. 14 stores the user ID, the affiliated organization name, and the title for each user (employee) in the corporation C. The affiliated organization name is the organization name of the organization to which the user pertaining to the user ID belongs. The title is the title of the user pertaining to the user ID.

For example, when a plurality of user IDs specified as authorizers include the User A, the User B, and a Manager 1, the fact that the User A and the User B are users who belong to the organization having the organization name “Project A” and the Manager 1 is a user whose title is Manager and who belongs to the organization having the organization name “SOFT 1,” is specified based on the user information storage unit 126. The fact that the “SOFT 1” is an organization higher than the “Project A” is specified based on the organization information storage unit 125. Accordingly, the Manager 1 is specified as a manager in an organization higher than the organization to which the User A and the User B belong. That is, the Manager 1 is specified as a superior of the User A and the User B. In this case, the authorizer excluding unit 14 excludes the User A and the User B who are authorizers in relatively low positions.

The order of execution of S112 and S114 may be reversed. Moreover, either one or both of S112 and S114 may be executed depending on the setting of the work flow creation device 10.

Next, the flow creating unit 15 creates the work flow information of the authorization flow based on the values of the variables P1 and P2 (S115). That is, the work flow information of the authorization flow is created such that the user pertaining to the user ID included in the variable P1 is appointed to be the authorizer and the user pertaining to the user ID included in the variable P2 is appointed to be the examiner. As a result, the authorization flow is created including the authorizer and the examiner as the transfer destinations for the usage application.

This method for creating the work flow information is not limited to the matters prescribed. For example, a model of the work flow information (the authorizer and the examiner are made into parameters) in which an authorizer or an examiner are not specified may be stored ahead of time in the auxiliary storage device 102. The flow creating unit 15 may create the work flow information of the authorization flow corresponding to the current usage application by applying the values of the variable P1 and the variable P2 into the work flow information of the model.

Next, the flow execution control unit 16 controls the execution of the authorization flow based on the work flow information created by the flow creating unit 15 (S116). For example, the authorization request pertaining to the usage application received in S101 is transmitted to the user terminals 20 of the authorizers having the user IDs included in the variable P1. If replies indicating authorization are received from all of the authorizers, the flow execution control unit 16 transmits an examination request to the user terminal 20 of the examiner pertaining to the user ID included in the variable P2.

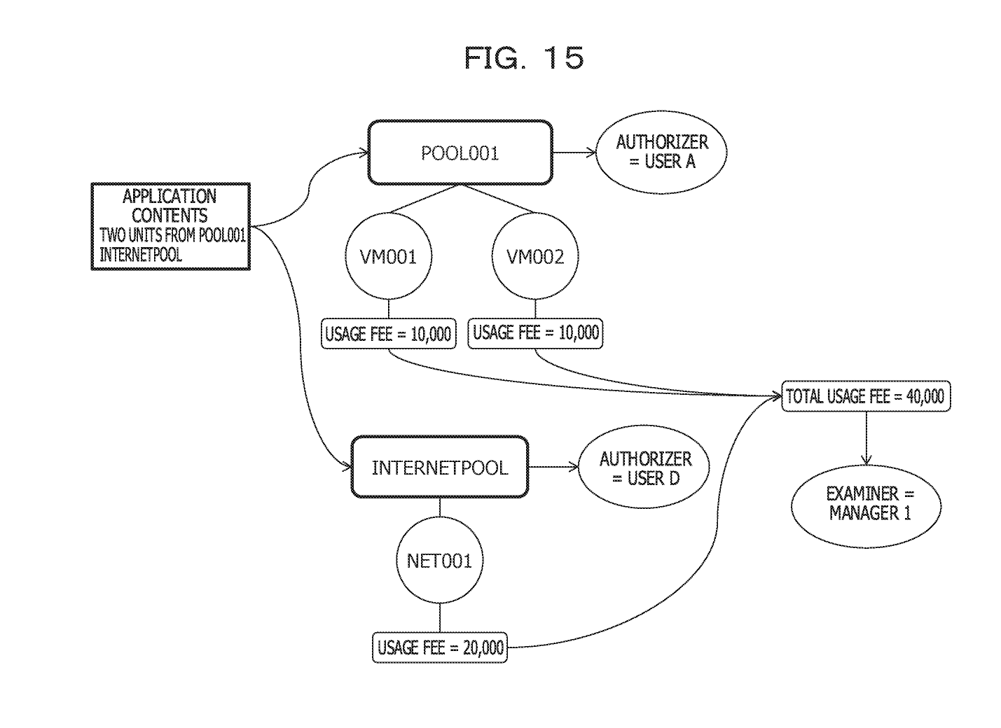

Next, the operating procedures explained with regard to FIG. 6 will be explained in detail. FIG. 15 is a view for explaining a first detailed example of an authorizer and examiner specification. The application contents of the usage application in FIG. 15 use “two units from POOL001” and “INTERNETPOOL”.

The “POOL001” is applied to the information stored in the pool information storage unit 121 and the User A is specified as one authorizer. The “INTERNETPOOL” is applied to the information stored in the pool information storage unit 121 and the User D is specified as one authorizer.

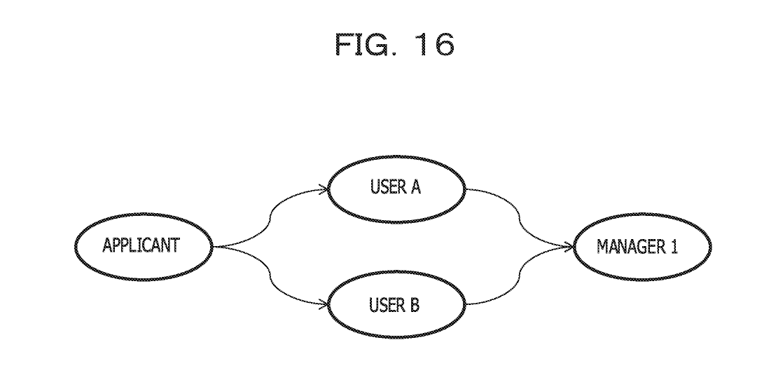

When “VM001” and “VM002” are set as the assigned resources among the VM resources belonging to the “POOL001”, the usage fees of the “VM001” and “VM002” are both understood to be 10,000 Yen per month. Conversely, when “NET001” is set as the assigned resource among the NET resources belonging to the “INTERNETPOOL”, the usage fee of the NET resource is understood to be 20,000 Yen per month. Therefore, the total amount of the usage fees comes to 40,000 Yen per month. The total amount is then applied to the information stored in the examination condition storage unit 127 and the Manager 1 is specified as the examiner. As a result, the authorization flow as depicted in FIG. 16 is created.

FIG. 16 illustrates a first example of an authorization flow. The authorization flow indicates that the authorization request of the usage application from the applicant is transferred to the User A and the User B, and the examination request of the usage application authorized by the User A and the User B is transferred to the Manager 1.

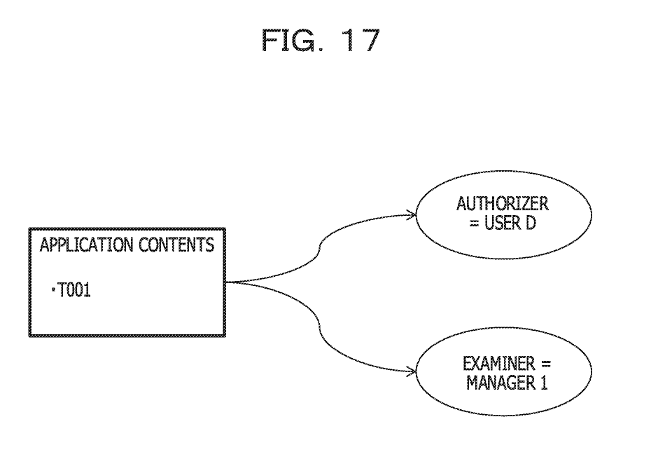

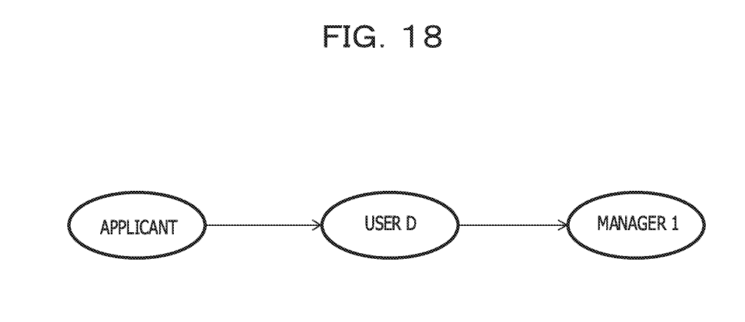

FIG. 17 is a view for explaining a second detailed example of example of an authorizer and examiner specification. The contents of the usage application depict “T001” as the template ID in FIG. 17. In this case, the “T001” is applied to the information stored in the template information storage unit 124 and the User D is specified as the authorizer and the Manager 1 is specified as the examiner. Thus in this case, the authorization flow as indicated in FIG. 18 is created.

FIG. 18 illustrates a second example of an authorization flow. The authorization flow indicates that the authorization request of the usage application from the applicant is transferred to the User D, and the examination request of the usage application authorized by the User D is transferred to the Manager 1.

As described above according to the present embodiment, the authorizer and the examiner in the authorization flow can be changed in response to the resource pool designated as the usage object in the usage application of the resource pool of the cloud service. That is, the administrator of the resource pool designated as the usage object is selected as the authorizer. Further, the user corresponding to the usage fee of the resources selected as the assigned resources from the resources belonging to the resource pool designated as the usage object, is selected as the examiner.

Therefore, flexibility of a work flow related to a usage application for resources of a cloud service can be improved.

When a new cloud service appears, the information such as the pool information storage unit 121, the VM information storage unit 122, or the NET information storage unit 123 may be changed if the resource pool or the resources offered by the existing cloud services are changed. That is, the defined contents of the work flow information may be changed. Therefore, the desire to revise the defined contents of the work flow information in response to a change of the cloud service can be reduced. As a result, an authorization flow corresponding to changes of a cloud service can be executed promptly.

When a plurality of authorizers are selected, a portion of the authorizers can be excluded based on the containment relationship among the resource pools and the hierarchical relationship among the authorizers. Therefore, even if a different authorizer is selected for each resource pool, an increase in the authorizers can be suppressed.

The present embodiment may be applied to a work flow related to usage application of resources for a computer system other than a cloud service.

The work flow creation device 10 in the present embodiment is an example of an information processing apparatus. The usage application receiving unit 11 is an example of a receiving unit. The examiner specifying unit 13 is an example of a first specifying unit. The flow creating unit 15 is an example of a creating unit. The authorizer excluding unit 14 is an example of a first excluding unit and a second excluding unit.

While the embodiments of the present disclosure have been described above, the present disclosure is not limited to the above-described embodiments and various improvements and modifications are possible without departing from the spirit of the disclosure as described in the scope of the claims.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An information processing apparatus comprising:
a memory; and
a processor coupled to the memory configured to:
receive a usage application in which at least one group among a plurality of groups including at least one resource related to a computer system is designated as a usage object,
specify at least one administrator corresponding to the at least one group by referring to group information including at least the plurality of groups and information about an administrator corresponding to each of the plurality of groups,
extract at least one authorizer from the at least one administrator based on a relationship between the at least one group and a relationship between the at least one administrator, and
generate a work flow including the at least one authorizer.

2. The information processing apparatus according to claim 1, wherein the processor is configured to
extract at least one authorizer from the at least one administrator by referring to the information indicating a containment relationship among the plurality of groups and by excluding an administrator corresponding to a contained group among the at least one group.

3. The information processing apparatus according to claim 1, wherein the processor is configured to
extract at least one authorizer from the at least one administrator by referring to a hierarchical relationship among the plurality of administrators and excluding an administrator having a relatively low position in the hierarchical relationship among the at least one administrator.

4. The information processing apparatus according to claim 1, wherein the processor is configured to:
select at least one assigned resource assigned to the usage application from the at least one group,
specify a total amount of a usage fee of the at least one assigned resource based on information indicating a usage fee for each of a plurality of resources included in the computer system,
refer to examiner condition information indicating an examiner according to a usage fee and specify an examiner to receive a work flow from the at least one authorizer and to examine the usage application based on the calculated total of the usage fee, and
generate work flow information including the at least one authorizer and the specified examiner.

5. The information processing apparatus according to claim 4, wherein the processor is configured to:
transmit an authorization request related to the usage application for one device among the devices of the at least one authorizer in accordance with the created work flow, and
transmit an examination request to a device of the specified examiner when a reply indicating authorization is received from all of the devices of the at least one authorizer.

6. The information processing apparatus according to claim 4,
wherein the examiner condition information is information that associates a range of usage fees with an identifier for identifying an examiner.

7. The information processing apparatus according to claim 4,
wherein the usage application includes information about respective quantities for each of at least one resource for which an application for use is made, and
the number of the assigned resources is determined based on the respective quantities.

8. The information processing apparatus according to claim 4, wherein the processor is configured to
generate the work flow by applying the at least one authorizer and the specified examiner to work flow information of a model in which an authorizer and an examiner are not specified.

9. A work flow creation method executed by a processor included in an information processing apparatus, the method comprising:
receiving a usage application in which at least one group among a plurality of groups including at least one resource related to a computer system is designated as a usage object;
specifying at least one administrator corresponding to the at least one group by referring to group information including at least the plurality of groups and information about an administrator corresponding to each of the plurality of groups;
extracting at least one authorizer from the at least one administrator based on a relationship between the at least one group and a relationship between the at least one administrator; and
generating a work flow including the at least one authorizer.

10. A non-transitory computer-readable storage medium storing a program that causes a processor included in a computer to execute a process, the process comprising:
receiving a usage application in which at least one group among a plurality of groups including at least one resource related to a computer system is designated as a usage object;
specifying at least one administrator corresponding to the at least one group by referring to group information including at least the plurality of groups and information about an administrator corresponding to each of the plurality of groups;
extracting at least one authorizer from the at least one administrator based on a relationship between the at least one group and a relationship between the at least one administrator; and
generating a workflow including the at least one authorizer.
